(19) United States
(12) Patent Application Publication
(10) Pub. No.: US 2023/0155269 A1
(43) Pub. Date: May 18, 2023

(54) HIGH POWER ISOLATOR HAVING COOLING CHANNEL STRUCTURE

(71) Applicant: ADMOTECH CO., LTD., Daejeon (KR)

(72) Inventors: OhGon CHUN, Daejeon (KR); BumKi Jeong, Sejong-si (KR); JungGu Lim, Daejeon (KR); ChangHwa Lee, Daejeon (KR)

(73) Assignee: ADMOTECH CO., LTD., Daejeon (KR)

(21) Appl. No.: 17/530,112

(22) Filed: Nov. 18, 2021

(51) Int. Cl. H01P 1/26; H01P 1/36; H01P 1/39

(52) U.S. Cl. CPC H01P 1/262; H01P 1/36; H01P 1/39

(57) ABSTRACT

A high power isolator having coolant channel structure includes a ferrite which is installed inside a junction of a waveguide; a permanent magnet which is installed in an outer groove of an upper part of the ferrite; and a water-cooled cooling device having a spiral-shaped water channel structure which is installed on the upper part of the permanent magnet; wherein the ferrite, the permanent magnet, and the water-cooled cooling device are formed in a symmetrical pair up and down.

### BACKGROUND OF THE INVENTION

### 1. Field of the Invention

The present invention relates to a high-power isolator for cooling with a coolant channel structure, and more particularly, it is a technique for improving cooling efficiency by forming a coolant channel structure for cooling of a high-power isolator.

### 2. Description of Related Art

An irreversible circuit element, such as an isolator or a circulator, is a high-frequency component designed to transmit a signal input through a predetermined port in one direction in accordance with Faraday rotation to be transmitted to another predetermined port.

With the growth of the wireless market, the demand for irreversible circuit elements such as isolators or circulators is increasing, and high output is required in plasma systems used in the semiconductor industry.

A circulator generally has three ports, and a signal input from each port is designed to be transmitted to another adjacent port with almost the same transmission and reflection coefficients. Therefore, each port is designed to perform only one role. That is, the signal that enters through the input port is transmitted through the output port, and the signal that enters the output port is transmitted to the terminating port to which the terminating resistor is connected and disappears. In the case of an ideal circulator, the signal input from the output port is blocked without being transmitted to the input port. Since the circulator has to have the same three port characteristics, symmetry of the components is required.

A microwave plasma system is widely used in thin film production of semiconductors and displays, nanomaterial synthesis, biodiesel synthesis and new drug synthesis, energy generation and large-capacity lighting devices, seawater, freshwater, toxic gas treatment, and household/industrial waste treatment. .

A high-power microwave plasma system of 5 kW or higher has a problem in that frequency transition occurs due to high-power signal input and frequency characteristics are degraded due to thermal temperature rise, and thus the entire signal module has to be replaced.

In order to prevent degradation caused by an increase in temperature of the isolator, a cooling water pipe made of a pipe was installed around the ferrite of the isolator in a conventional manner, but local cooling was not uniform and cooling efficiency was not high.

### SUMMARY OF THE INVENTION

In order to solve the above problems, the present invention is to provide a high-output isolator with high uniform cooling and high cooling efficiency by forming a cooling device in a channel structure instead of a conventional water pipe structure.

In the coolant channel structure cooling high-power isolator according to the present invention for the above-mentioned problem to be solved, a ferrite is installed inside the junction of the waveguide, and a permanent magnet is installed in an outer groove of the ferrite upper part, and the permanent magnet is installed. A water-cooled cooling device having a water-channel structure of a spiral shape is installed above the permanent magnet, and the water-cooled cooling device having a ferrite, permanent magnet and a water-channel structure is formed in a vertically symmetrical pair.

The cooling device is characterized in that the cooling water is injected into a water inlet, flows along the water channel groove, cools the isolator junction, and is rotated in reverse at a center to be discharged to a water outlet.

In the cooling device, an O-ring groove for inserting an O-ring is formed in order to prevent water leakage, a water channel groove of a spiral structure is formed, and a cover fixed to a coupling hole with a screw.

### BRIEF DESCRIPTION OF THE DRAWINGS

FIG. 1 is (a) a perspective view and (b) a vertical cross-sectional view of a coolant channel structure cooling high-power isolator according to the present invention.

FIG. 2 is (a) a perspective view and (b) a vertical cross-sectional view of a coolant channel structure according to the present invention.

FIG. 3 is a vertical cross-sectional view of another embodiment of a coolant channel structure according to the present invention.

### DETAILED DESCRIPTION OF THE INVENTION

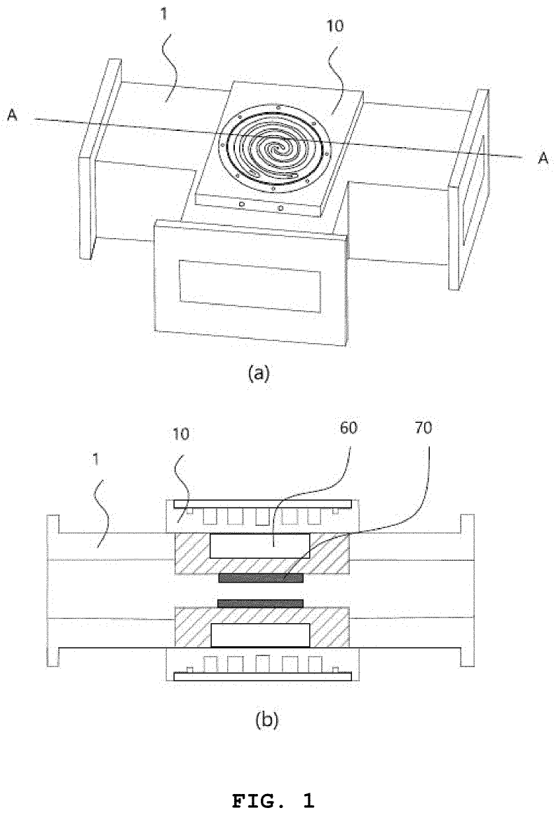

FIG. 1 (a) is a perspective view of a coolant channel structure cooling high-power isolator according to the present invention, and FIG. 1 (b) is a cross-sectional view perpendicular to the line A-A of (a). The drawing shows a waveguide-type right-angle isolator, but is not limited thereto, and can be applied to all high-output devices such as a Y-tube type isolator.

FIG. 1 is an embodiment of a coolant channel structure cooling high-power isolator 1, the main configuration of which is that a ferrite 60 is installed inside a junction of a waveguide, a permanent magnet 70 is installed in an external groove, and a water-cooled cooling device 10 having a water channel structure is installed on top of the permanent magnet, and the components are formed in a vertical symmetrical pair.

The ferrite is a magnetic material that strengthens the induced magnetic field of the permanent magnet, and the ferrite for high output is formed in a large area, so manufacturing cost is high, processing is difficult, and damage or breakage may be caused by thermal strain.

A conventional cooling is water-cooled by installing a cooling water pipe made of a pipe around a permanent magnet from the outside of the waveguide. The ferrite was indirectly cooled by local cooling by installing a water pipe around it, so that the cooling was not uniform and the cooling efficiency was not high.

In order to solve the above problems, the present invention installs a cooling device 10 having a structure of a water channel 30 in a spiral form on the upper part of the permanent magnet and the surface of the waveguide.

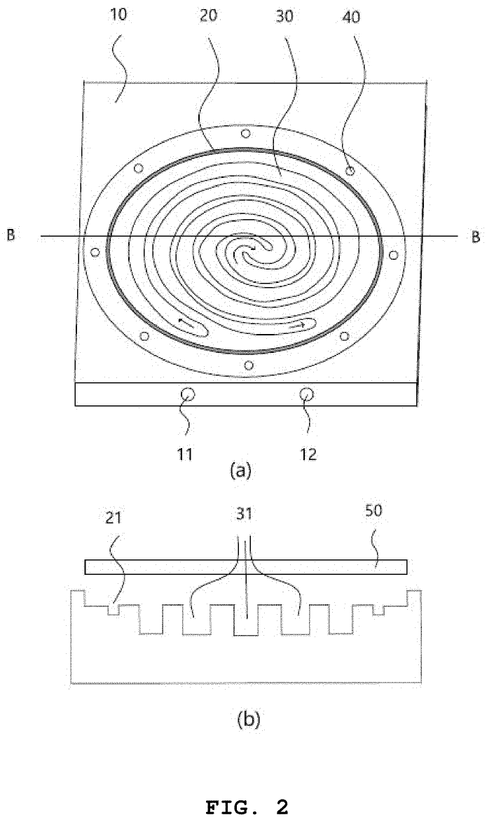

As shown in FIG. 2 (a), the cooling water injected into a water inlet 11 flows along a spiral channel groove 31 that forms the water channel of the cooling device, cools the lower part, and rotates in reverse at the central part and is discharged to an outlet 12.

FIG. 2 (b) is a cross-sectional view showing a cross-sectional view perpendicular to line B-B, in which a channel groove 31 of a spiral structure is formed, an O-ring groove 21 for inserting an O-ring to prevent water leakage is formed, and a cover 50 is covered and fixed to a coupling port 40 with a screw or the like.

The water-cooled cooling device of the water-channel structure according to the present invention completely covers an area that cannot be covered by the conventional water-pipe structure and the cooling water flows in a spiral, so the cooling efficiency is remarkably superior.

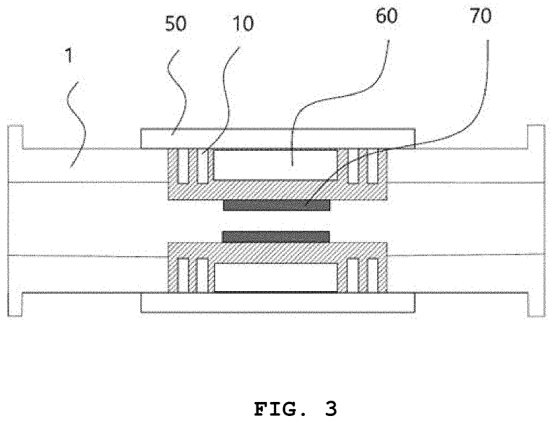

In another embodiment of the present invention, it is possible to form a water channel directly in the main body of a isolator and cover a cover without removing a cooling device as shown in FIG. 3.

What is claimed is:

1. A high power isolator having coolant channel structure, comprising:
a ferrite which is installed inside a junction of a waveguide;
a permanent magnet which is installed in an outer groove of an upper part of the ferrite; and
a water-cooled cooling device having a spiral-shaped water channel structure which is installed on the upper part of the permanent magnet;
wherein the ferrite, the permanent magnet, and the water-cooled cooling device are formed in a symmetrical pair up and down.

2. The high power isolator of claim 1,
wherein cooling water is injected into a water inlet, flows along a water channel groove to cool an isolator junction, and rotates in reverse at a center to be discharged to a water outlet in the water-cooled cooling device.

3. The high power isolator of claim 1,
wherein a channel groove of a spiral structure is formed,
an O-ring groove for inserting an O-ring is formed to prevent water leakage,
a cover is fixed to a coupling hole with screws.

4. A high power isolator having coolant channel structure, comprising:
a ferrite which is installed inside a junction of a waveguide;
a permanent magnet which is installed in an outer groove of an upper part of the ferrite; and
a water-cooled cooling device is installed to form a water channel groove in an isolator body around the permanent magnet and cover a cover.
wherein the ferrite, the permanent magnet, and the water-cooled cooling device are formed in a symmetrical pair up and down
